(19) United States
(12) Patent Application Publication
(10) Pub. No.: US 2008/0155518 A1
(43) Pub. Date: Jun. 26, 2008

(54) METHODS AND APPARATUS FOR TOKENIZING WORKFLOW PROCESS OBJECTS

(75) Inventors: Adriaan Van Wyk, Strubensvalley (ZA); Natachya Raath, Vanderbijlpark (ZA); Lenz le Roux, Radiokop (ZA); Wynand du Toit, Little Falls (ZA); Olaf Wagner, Issaquah, WA (US); Ben Fourie, Radiokop (ZA); Schalk de Jager, Weltevreden Park (ZA); Pieter Janson, Centruion (ZA)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 11/945,906

(22) Filed: Nov. 27, 2007

Related U.S. Application Data
(60) Provisional application No. 60/939,286, filed on May 21, 2007.
(60) Provisional application No. 60/867,344, filed on Nov. 27, 2006.

(51) Int. Cl. G06F 9/45

(52) U.S. Cl. 717/142

(57) ABSTRACT

The present disclosure provides methods and apparatuses for tokenizing workflow process objects. Using the methods and apparatus herein, users can create business processes that contain several variable components. This allows business process designers to save time by designing template business processes whose processes change based on the environment that they deployed in.

### CROSS-REFERENCE TO RELATED APPLICATIONS

The present application claim benefit to U.S. Patent Application No. 60/867,344, METHOD AND APPARATUS FOR CREATING WORK FLOW, filed on Nov. 27, 2006; and U.S. Patent Application No. 60/939,286, METHODS AND APPARATUS FOR TOKENIZING WORKFLOW PROCESS OBJECTS, filed on May 21, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Some business process designers use graphical business process design software to create graphical workflows. The graphical software may use graphical objects to represent business processes and workflow activities. Business processes designers may design common business processes that contain the same or similar workflow activities, but require different data streams, or only vary slightly in their workflow activities. Currently, business process designers are required to create entirely different business processes to fully capture the different workflows.

Some business process designs require a solution to be developed in a development environment, tested in a test environment, and once approved, deployed in a production environment. Because there are different environments involved, and because many organizations progressively lock down permissions through the process (i.e., developers have full control in the development environment, less control in the test environment, and may not have access at all to production), the deployment tools have been integrated into the build process to enable deployment to different environments.

### SUMMARY

The present disclosure provides methods and apparatuses for tokenizing workflow process objects. Using the methods and apparatus herein, users can create business processes that contain several variable components. This allows business process designers to save time by designing template business processes whose processes change based on the environment that they deployed in.

Additional features and advantages are described herein, and will be apparent from, the following Detailed Description and the figures.

### BRIEF DESCRIPTION OF THE FIGURES

FIG. 1 is a high level block diagram of an example business process design system.

FIG. 2 is a more detailed block diagram showing one example of a client device.

FIG. 3 is a more detailed block diagram showing one example of a server.

FIG. 4 is a diagram of an example environment library system.

FIG. 5 is an example screenshot of a database model.

FIG. 6 is an example screenshot of field value table.

FIG. 7 is an example screenshot of a visual folder system representation.

FIG. 8 is an example screenshot of switching an environment.

FIG. 9 is an example screenshot of switching a template.

FIG. 10 is an example screenshot of a template choice screen.

FIG. 11 is an example environment field editing screen.

FIG. 12 is an example development process using Environment Library tokens.

FIG. 13 is an example of a deployment process.

### DETAILED DESCRIPTION

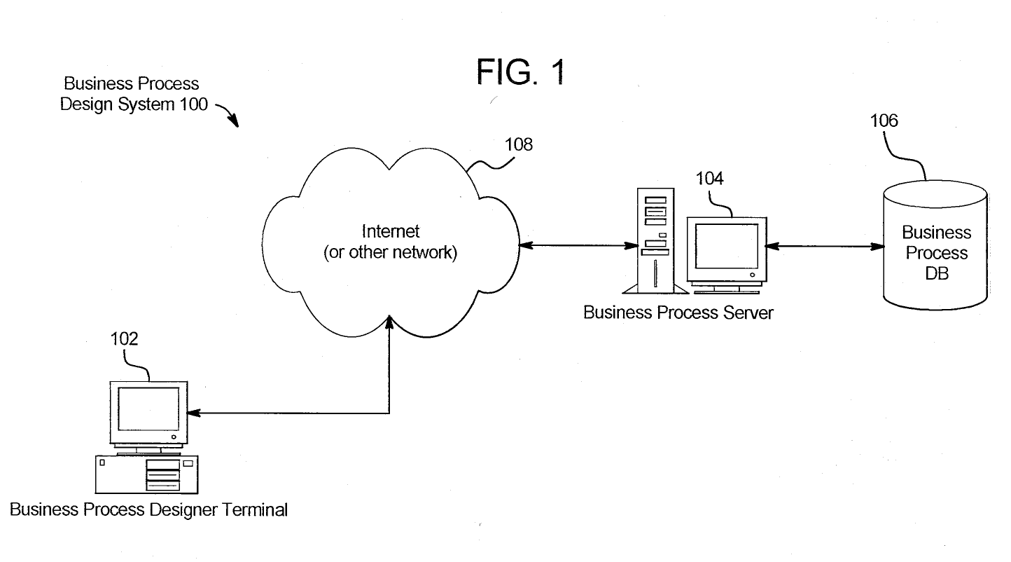

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

The business process database 106 serves as a centralized store for all artifact data and is driven by parameterized stored procedures.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

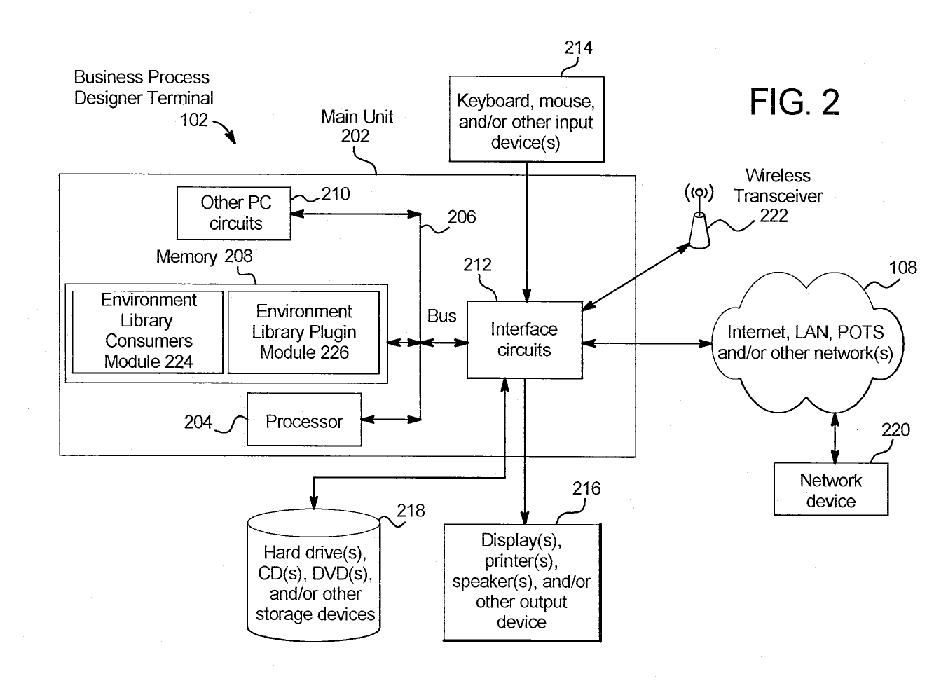

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214. Preferably, the memory 208 stores a software program that implements all or part of the method described below.

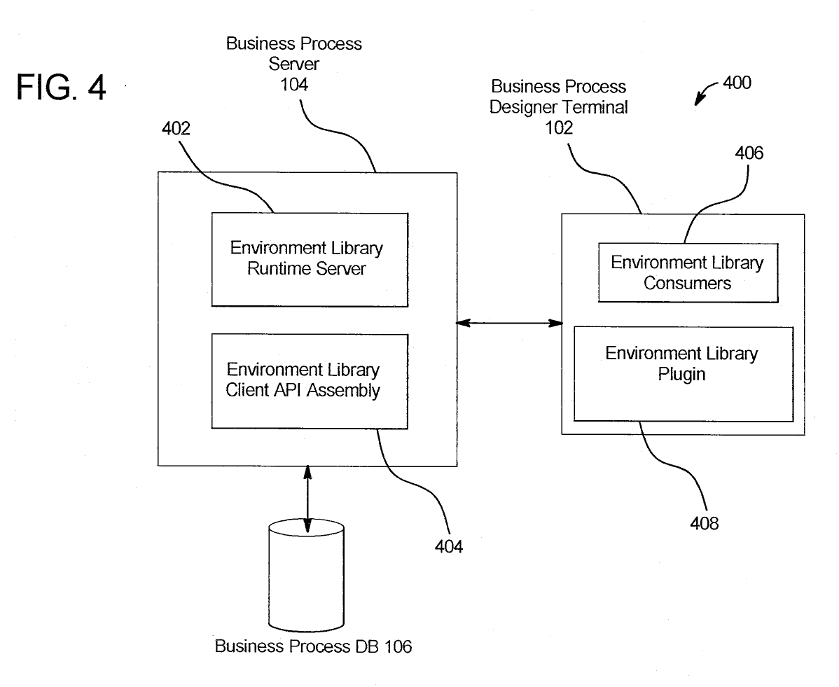

In particular, the memory 208 preferably stores an environment library consumers module 224 and an environment library plugin module 226. The environment library consumers module 224 may contain the instructions to carry out the functions of the environment library consumers 406, further discussed in relation to FIG. 4. The environment library plugin module 226 may contain the instructions to carry out the functions of the environment library plugin 408, further discussed in relation to FIG. 4.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

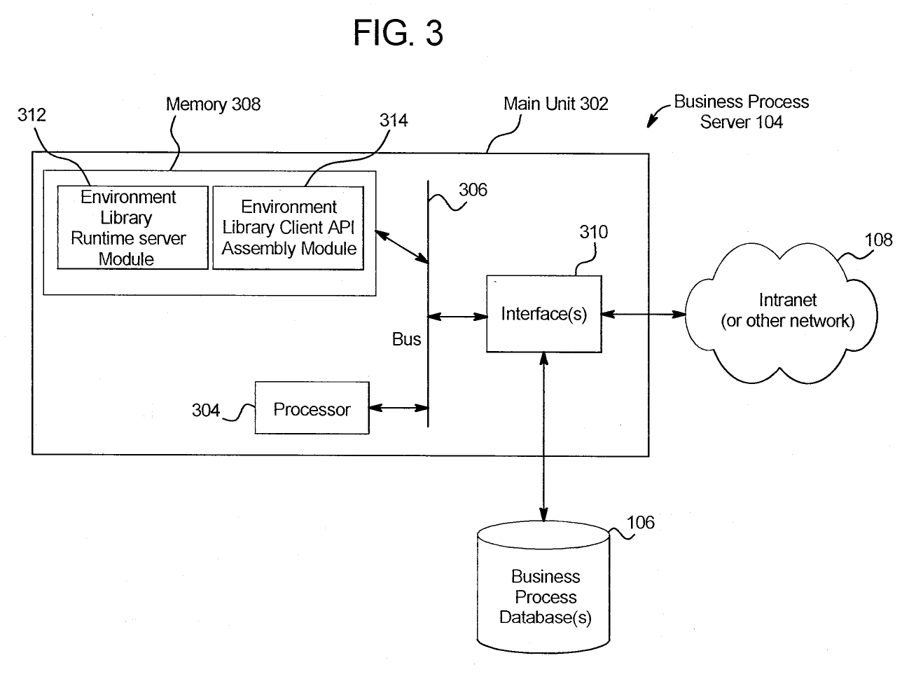

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory 308 preferably stores an environment library runtime server module 312 and an environment library client API assembly module 314. The environment library runtime server module 312 may contain the instructions to carry out the functions of the environment library runtime server 402, further discussed in relation to FIG. 4. The environment library client API assembly module 314 may contain the instructions to carry out the functions of the environment library client API assembly module 404, further discussed in relation to FIG. 4.

A diagram of an example environment library system 400 is presented in FIG. 4. Although the example environment library system 400 is described in reference FIG. 4, it will be appreciated that many other configurations are possible. For example, elements could be in different locations, elements could have different names, and elements could have different graphical representations.

The environment library system 400 may have a business process server 104 and a business process designer terminal 102. It should be understood that the business process server 102 may be a plurality of connected servers and that components may be located on separate servers. The business process server 104 may have an environment library runtime server component 402 and an environment library client API assembly 404.

The business process database 106 may store all artifact data and is driven by parameterized stored procedures. The data in the business process database 106 may be indexed to improve performance. The business process database 106 may conform to the ACID principles of database transaction management, otherwise known as atomicity, consistency, isolation and durability.

The environment library runtime server component 402 may create a wrapper around the parameterized stored procedures in the business process database 106. The environment library runtime server component 402 may also decide what data a business process designer at a business process designer terminal 102 may receive based on the business process designer's security settings.

The environment library client API assembly 404 may assemble data received from the stored procedures in the business process database 106 and expose the data as PersistableObjectCollections providing an easy to use abstraction to clients of the API. The client API may dynamically load field types and allow for swapping of environments, filtering, searching, etc.

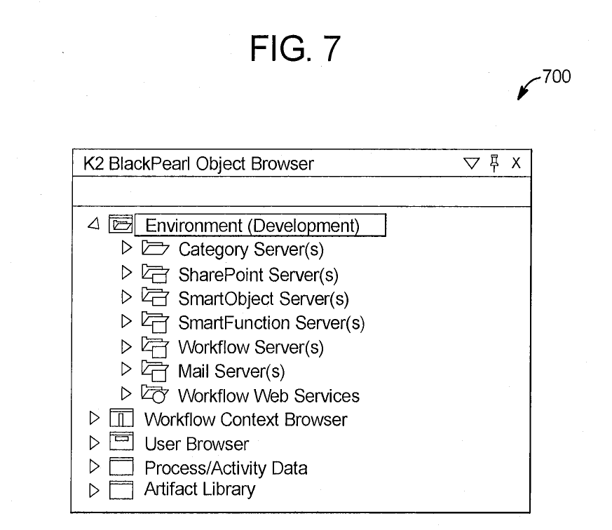

The environment library plugin 408 may expose the environment library data to the business process designer. For example, the environment library plugin 408 may create a visual folder system representation 700 of the environment library, as seen in FIG. 7. The environment library plugin may provide the business process designer with a visual cue to the user as to which environment the user is currently working under, see FIG. 7.

The environment library plugin 408 may assist in initially loading the environment. For example, if the initial process does not contain a reference to a business process server 104, the environment library plugin 408 may attempt to load a default business process server 104 from a file cached on the business process designer terminal 102. If a connected business process server 104 is found, the environment library plugin 408 may then attempt to connect to an environment that is saved as part of the process or the cache on the business process designer terminal 102. If an existing environment is not found as part of the process, or the cache, the environment library client API assembly 404 requests the default template and environment from the currently connected business process server 104. A template may be a set of fields that require values and an environment may be the values for the fields. Once a valid environment is connected, the environment library plugin 408 instructs the environment library client API assembly 404 to download data for that environment. Once the data is downloaded, the environment library client API assembly 404 uses assembly information from the business process database 106 to create instances of the field type by reflection. The environment library plugin 408 then attempts to dynamically load the associated plugins. This scenario may occur when a business process designer attempts to switch business process servers 104 or environments.

The environment library plugin 408 may also allow business process designer to add new templates, environments, fields, etc. Also, field values may be administered by use of the environment library plugin 408. In addition, security may be assigned on environments and templates. Environments under a template may inherit permissions, where the parent-child relationship has not been broken by modifying the permissions on a single environment to be different from that of its parent template. Environments may have a number of security settings. For example, read-only, modifiable, etc.

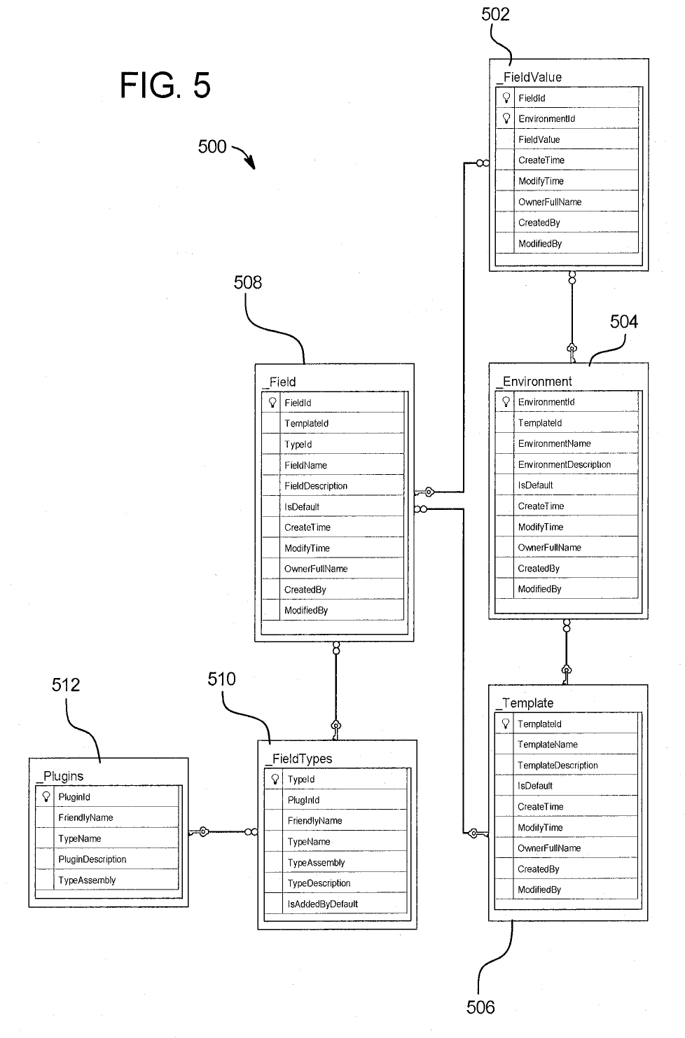

A screenshot of an example database model is presented in FIG. 5. Although the example database model 500 is described in reference FIG. 5, it will be appreciated that many other configurations are possible. For example, elements could be in different locations, elements could have different names, and elements could have different graphical representations.

The business process database 106 contain a database storing data associated with environments and templates. The database model 500 is an example layout of the database. The database model may have a template table 506. For example, a template table 506 may contain data identifying a template such as a template ID field, template name, etc.

The template ID may serve as a key for an environment table 504. The template ID may also serve as a key for a field table 508. The field table 508 may contain data associated with fields that may vary in value based on environment. The field ID may server as a key from the field table 508 to the field value table 502. The field value table 502 may contain data associated with values that will vary based on environment. The environment ID may serve as a key from the environment table 504 to the field value table 502.

A field type table 510 may store information associated with field types. The field type ID may serve as a key for a field table 508. A plugins table 512 may store data associated with plugins that are associated with a field type. The plugin ID may serve as a key from the plugin table 512 to the field type table 510.

The environment table 504 may store information associated with environments. The environment table 504 may serve as a link between the field values for each template

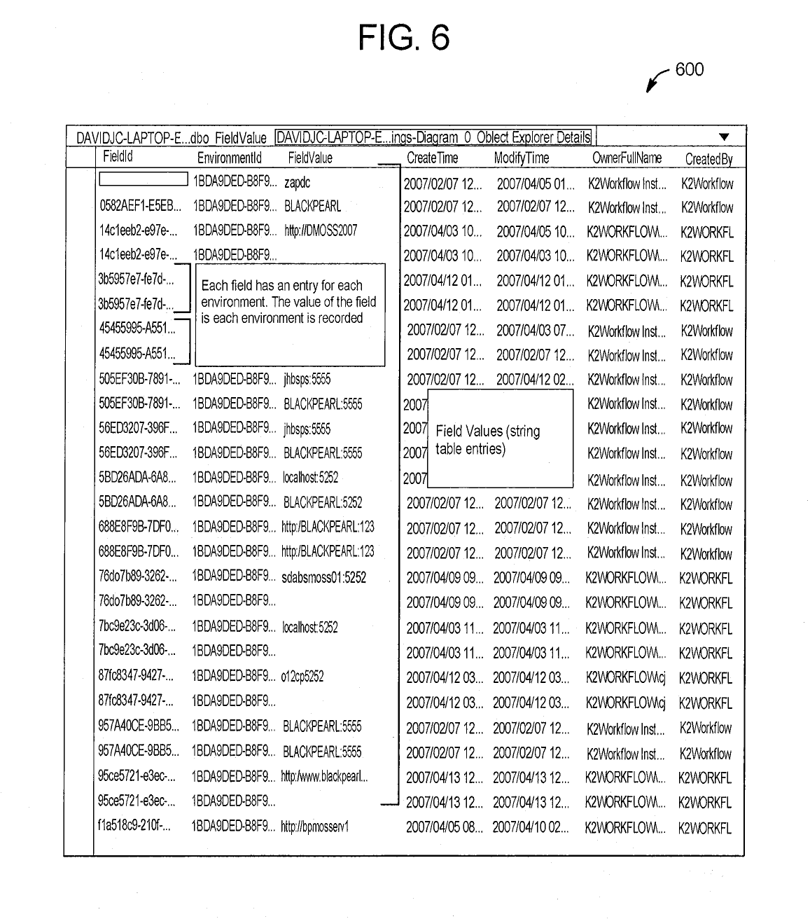

A screenshot of an example field value table 502 is presented in FIG. 6. Although the example field value table 502 is described in reference FIG. 6, it will be appreciated that many other configurations are possible. For example, elements could be in different locations, elements could have different names, and elements could have different graphical representations.

The field value table 502 may associate different fields with field values for environments. The field value table 502 allows different environments to fill fields with different values.

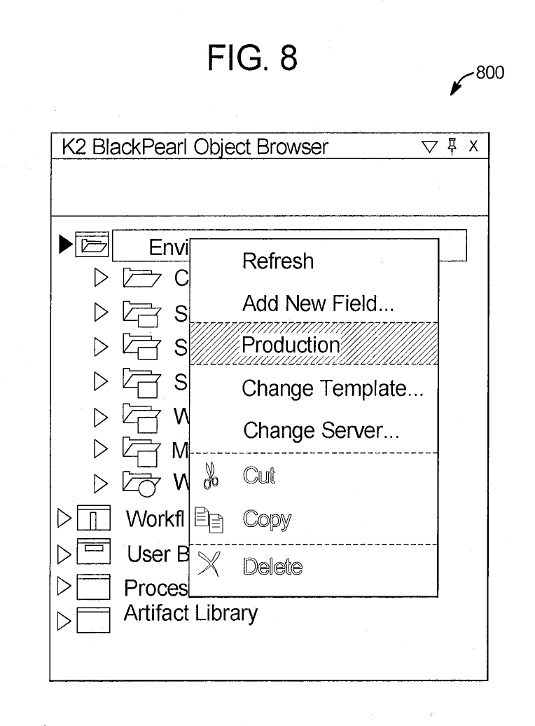

A screenshot of switching an environment is presented in FIG. 8. Although the example switching an environment is described in reference FIG. 8, it will be appreciated that many other configurations are possible. For example, elements could be in different locations, elements could have different names, and elements could have different graphical representations.

Multiple environments may be stored on the business process server 104. The environment library plugin 408 may only display environments that the business process designer has access to view. For example, environment privileges may be granted on a template or environment. Depending on environment or template privileges, certain environments may not be downloaded to the business process designer terminal 102 from the server. Therefore the list visible in the context menu 800 is dependent on the business process designer's access rights for the current environment. For example, the “Production” environment may be the only environment that the business process designer may access, and may be the only environment shown on the context menu 800.

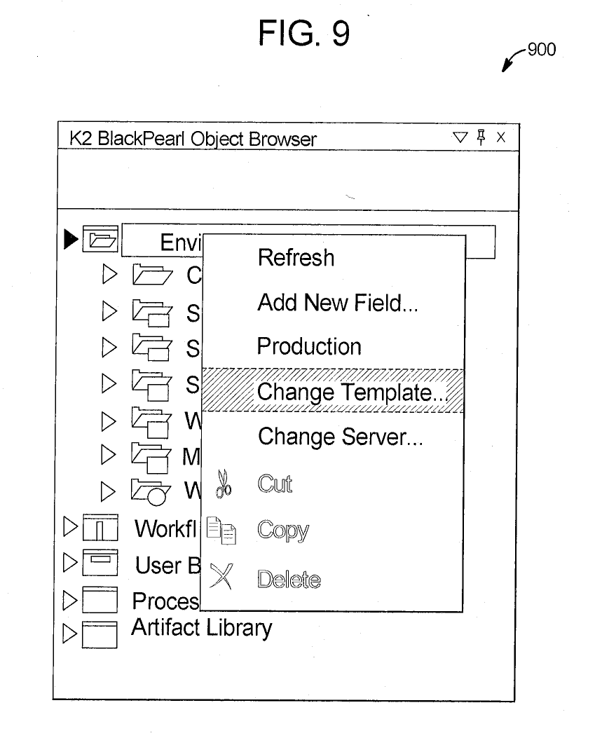

A screenshot of an switching a template is presented in FIG. 9. Although the example switching a template is described in reference FIG. 9, it will be appreciated that many other configurations are possible. For example, elements could be in different locations, elements could have different names, and elements could have different graphical representations.

The environment library plugin 408 may also facilitate changing a template. As with the environments, the templates may have security settings that determine whether the templates will be available to the business process designer. For example, the business process designer may be able to select a “Change Template” option on the context menu 900.

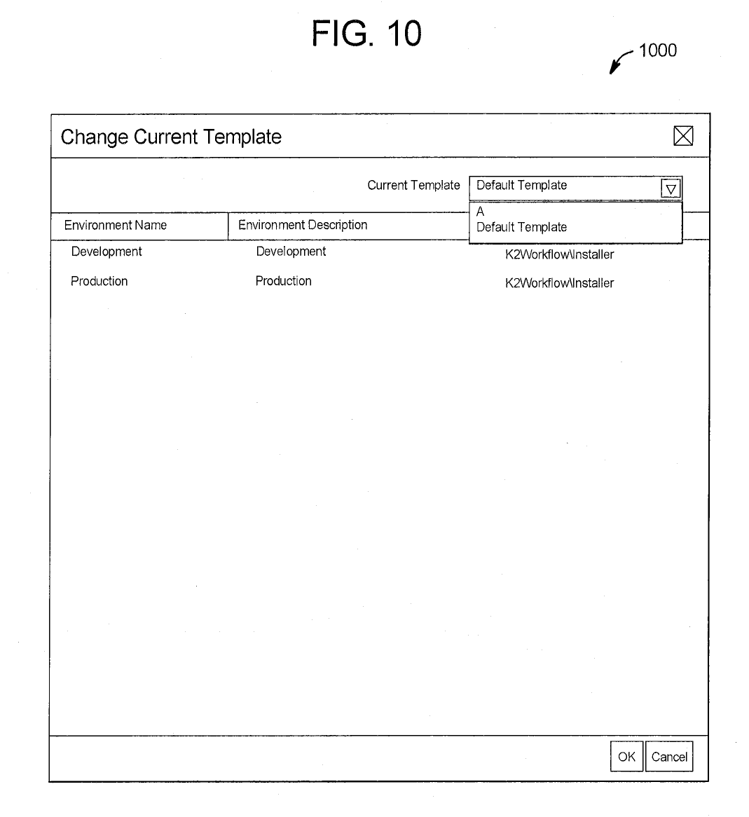

A screenshot of a template choice screen is presented in FIG. 10. Although the example template choice screen is described in reference FIG. 10, it will be appreciated that many other configurations are possible. For example, elements could be in different locations, elements could have different names, and elements could have different graphical representations.

When attempting to change a template, the environment library plugin 408 may display a template choice screen 1000. The template choice screen may contain information regarding available environments.

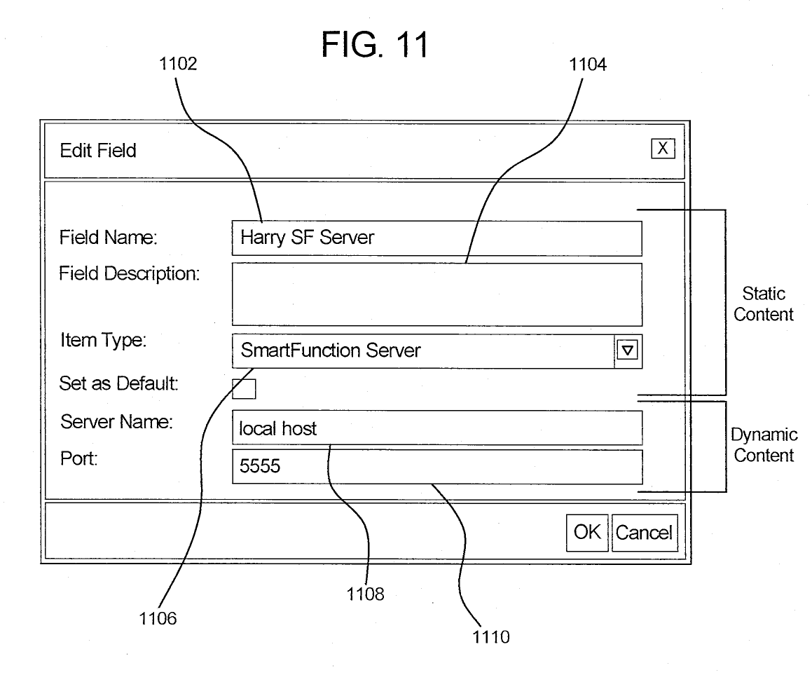

A screenshot of environment field editing screen is presented in FIG. 11. Although the example environment field editing screen in reference FIG. 11, it will be appreciated that many other configurations are possible. For example, elements could be in different locations, elements could have different names, and elements could have different graphical representations.

The environment library plugin 408 may utilize the information stored in the environment client API assembly 404, or business process database 106, to manage a certain field type. This is possible because the environment library is extensible to allow custom user-defined types and associated plugins. The environment library plugin 408 may transmit to the business process design terminal 102 a field editing screen 1100. The field editing screen 1100 may have inputs for the business process designer to edit an environment field. For example, the field editing screen 1100 may have editing fields for a field name 1102, field description 1104, item type 1106, server name 1108, port 1110, etc.

The environment library plugin 408 may also assist a business process designer in adding new field types. For example, the environment library plugin 408 may provide a business user with the ability to add a new field type and associate that field type with a plugin.

The environment library plugin 408 may also present the user with a number of standard functions to access the environment library directly. For example, a program may require access to an environment's default field values.

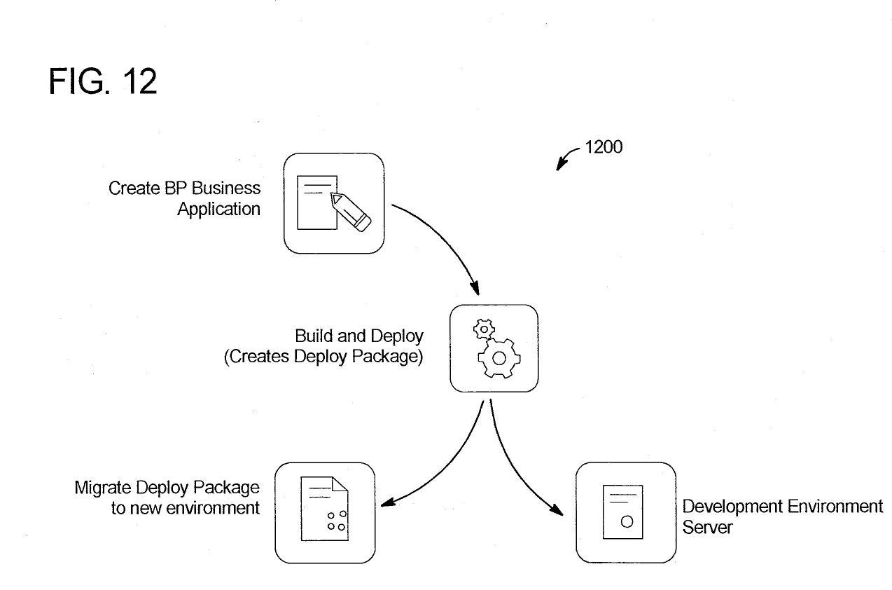

An example development process using Environment Library tokens 1200 is presented in FIG. 12. Although the example development process using Environment Library tokens 1200 is displayed in reference FIG. 12, it will be appreciated that many other configurations are possible. For example, elements could be in different locations, elements could have different names, and elements could have different graphical representations.

The values for all environments configured during business process design are utilized when a process is deployed to a particular environment. The values are retrieved from the environment library when a deployment package is created as indicated in FIG. 12.

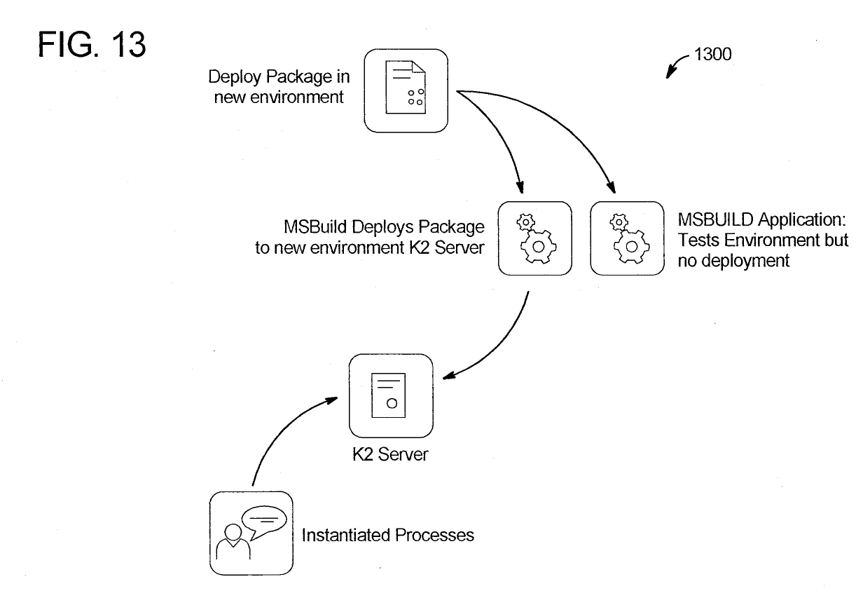

An example deployment process 1300 is presented in FIG. 13. Although the example deployment process 1300 is displayed in reference FIG. 13, it will be appreciated that many other configurations are possible. For example, elements could be in different locations, elements could have different names, and elements could have different graphical representations.

When the deployment package is used to deploy a process to a particular environment as shown in FIG. 13, the values for the tokenized objects are replaced with the field values for that environment. As with the templates, the business process servers may have security settings that determine whether the person deploying the package has rights to the various environments. The deployment package can be used to test the environment field values and resources to ensure that the business process will function once deployed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for tokenizing a workflow process artifact, the method comprising:
creating a workflow process artifact, wherein the workflow process artifact includes a variable parameter;
creating a workflow environment, wherein the workflow environment includes a variable parameter value;
loading the workflow environment; and
using the workflow process artifact in the workflow environment, wherein using the workflow process artifact includes using the variable parameter value for the variable parameter.

2. The method of claim 1, wherein the workflow environment includes an environment security setting.

3. The method of claim 2, including determining an access to the variable parameter value based on the environment security setting and a user security setting.

4. The method of claim 1, including creating a template, wherein the template includes the variable parameter, and wherein the workflow environment is associated with a template.

5. The method of claim 4, wherein the template includes a template security setting.

6. The method of claim 1, including:
creating a second workflow environment, wherein the second workflow environment includes a second variable parameter value; and
switching from the workflow environment to the second workflow environment, wherein switching from the workflow environment to the second workflow environment includes dynamically loading the second variable parameter value.

7. A system for tokenizing a workflow process artifact, the system comprising:
a processor for:
creating a workflow process artifact, wherein the workflow process artifact includes a variable parameter;
creating a workflow environment, wherein the workflow environment includes a variable parameter value;
loading the workflow environment; and
using the workflow process artifact in the workflow environment, wherein using the workflow process artifact includes using the variable parameter value for the variable parameter.

8. The system of claim 7, wherein the workflow environment includes an environment security setting.

9. The system of claim 8, wherein the processor additionally determines an access to the variable parameter value based on the environment security setting and a user security setting.

10. The system of claim 7, wherein the processor additionally creates a template, wherein the template includes the variable parameter, and wherein the workflow environment is associated with a template.

11. The system of claim 10, wherein the template includes a template security setting.

12. The system of claim 7, wherein the processor additionally:
creates a second workflow environment, wherein the second workflow environment includes a second variable parameter value; and
switches from the workflow environment to the second workflow environment, wherein switching from the workflow environment to the second workflow environment includes dynamically loading the second variable parameter value.

13. A computer readable medium storing instructions structured to cause a computing device to:
creating a workflow process artifact, wherein the workflow process artifact includes a variable parameter;
create a workflow environment, wherein the workflow environment includes a variable parameter value;
load the workflow environment; and
use the workflow process artifact in the workflow environment, wherein using the workflow process artifact includes using the variable parameter value for the variable parameter.

14. The computer readable medium of claim 13, wherein the workflow environment includes an environment security setting.

15. The computer readable medium of claim 14, wherein the instructions are structured to cause the computing device to determine an access to the variable parameter value based on the environment security setting and a user security setting.

16. The computer readable medium of claim 13, wherein the instructions are structured to cause the computing device to create a template, wherein the template includes the variable parameter, and wherein the workflow environment is associated with a template.

17. The computer readable medium of claim 16, wherein the template includes a template security setting.

18. The computer readable medium of claim 13, wherein the instructions are structured to cause the computing device to:
create a second workflow environment, wherein the second workflow environment includes a second variable parameter value; and
switch from the workflow environment to the second workflow environment, wherein switching from the workflow environment to the second workflow environment includes dynamically loading the second variable parameter value.
